(19) United States
(12) Patent Application Publication
(10) Pub. No.: US 2001/0039617 A1
(43) Pub. Date: Nov. 8, 2001

(54) SYSTEM FOR THE TRANSMISSION OF DATA BETWEEN AT LEAST ONE WRITE/READ STATION AND A PLURALITY OF DATA CARRIERS

(75) Inventors: MARTIN BUHRLEN, GROSSTEINBACH (AT); SIEGFRIED ARNOLD, GRAZ (AT)

Correspondence Address: CORPORATE PATENT COUNSEL, U S PHILIPS CORPORATION, 580 WHITE PLAINS ROAD, TARRYTOWN, NY, 10591

(73) Assignee: U. S. Phillips Corporation

(21) Appl. No.: 08/809,328

(22) PCT Filed: Jul. 8, 1996
(86) PCT No.: PCT/IB96/00656

§ 371 Date: None

(30) Foreign Application Priority Data
Jul. 18, 1995 (AT) A 1225/95

(51) Int. Cl. H04K 1/00

(52) U.S. Cl. 713/185; 380/46

(57) ABSTRACT

In a system for the transmission of data between at least one write/read station and a plurality of data Carriers, inductive coupling is used to transmit energy and clock pulses from the write/read station to the data carrier. Data is transmitted either in the opposite direction only or bidirectionally. The data carrier in accordance with the invention is provided with a random number generator (6) which can store a random number in a memory (3), preferably under the control of the write/read station. If this random number forms part of the code to be transmitted by the data carrier, a so-called rolling code access control system can be simply implemented, that is to say an access control system in which the codes are changed at regular intervals.

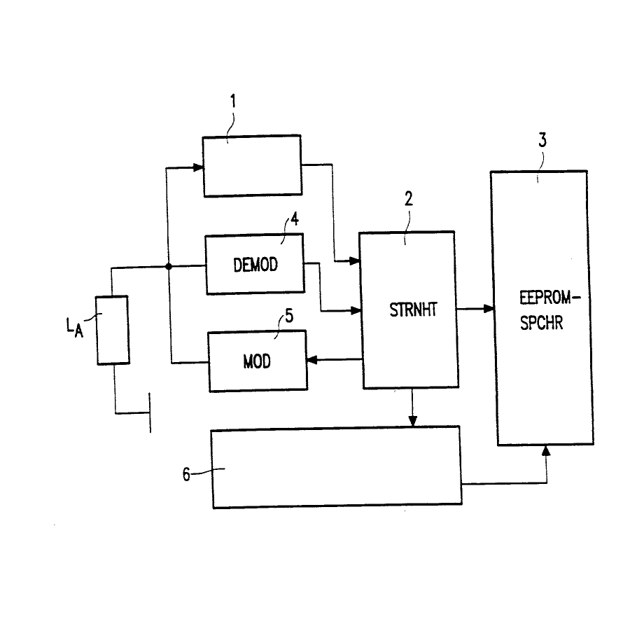

The present invention relates to a system for the transmission of data between at least one write/read station and a plurality of data carriers, inductive coupling between write/read station and data carriers being used to transmit energy and clock signals to the data carrier as well as data from the data carrier to the write/read station.

Data carriers serve as intelligent, mobile data stores which are used for the writing or reading of data in the near field of write/read stations. Systems of this kind are used with a wide variety of transmission ranges, data transmission speeds, degrees of integration, storage capacities, levels of intelligence of the data carriers etc. for a wide variety of applications such as access control, industrial and commercial object identification, animal identification, immobilization, automatic traffic ticket monitoring etc.

A data transmission system of the kind set forth is known from Austrian Patent No. 395,224. The write/read station in the known data transmission system transmits an RF signal. The operating voltage is generated in the data carrier by rectifying the RF signal. Furthermore, the clock pulses are also derived from the RF signal, for example by frequency division. Load modulation is used to transmit data from the data carrier to the read/write station: in the data carrier the antenna coil, or a part thereof, is short-circuited or loaded by a resistor in order to transmit, for example a “1” whereas it remains unloaded so as to transmit a “0”. These loads can be recognized and evaluated in the write/read station.

Because of their ease of manufacture and hence extremely low manufacturing costs, fixed code data carriers are now most commonly used for a wide variety of applications. In the case of fixed code data carriers, no data is transmitted from the write/read station to the data carrier. During the manufactuing process a fixed code word (usually having a length of between 32 and 256 bits) is stored in such a manner that it cannot be manipulated (for example, by means of laser programming techniques).

In order to transmit data also from the write/read station to the data carrier in the case of writable/readable data carriers, pulse-spacing modulation can be used: the RF signal is briefly interrupted at given intervals and the time elapsing between the interruptions is used to determine whether a “0” or a “1” is transmitted. This time can be determined in the data carrier simply by counting clock pulses. If a number exceeding a given value is counted between two interruptions, a “1” was transmitted and otherwise a “0” (or vice versa). The data transmitted is stored, for example in an EEPROM.

For given applications (security techniques, access authorization), non-authorized persons (“intruders”) should not be in a position to simulate a data carrier by means of a model, since otherwise serious damages could be incurred by an operator of the system.

In state of the art systems of this kind the data stored on a data carrier is not transmitted as text in clear, but is manipulated by means of specific encryption devices in such a manner that intruders cannot interpret or simulate the data. The write/read station transmits a keyword to the data carrier and on the basis thereof encryption is performed in the data carrier and decryption in the write/read station.

It is a drawback that, depending on the protection standard achieved, such encryption devices can be implemented at the data carrier side only by using a comparatively large amount of hardware; moreover, the known encryption methods require data transmission in both directions. This means that the data carrier must be provided with a demodulator even if no data (except for the keyword) is to be transmitted to the data carrier in a given application. This fact and the encryption circuit lead to a comparatively intricate and hence expensive manufacture of the data carrier.

On the other hand, if encryption and decryption of the data is also performed in an application where data is also transmitted from the write/read station to the data carrier, it is a drawback that an intruder knowing the encryption method can determine the transmitted data in as far as he can receive only the strong RF carrier of the read/write station.

It is an object of the invention to improve a data transmission system in respect of protection against manipulation and espionage by means of an additional device which can be readily implemented. A substantially higher level of protection is to be achieved in comparison with simple fixed code data carriers or also writable/readable data carriers, without complex encryption functions being required for this purpose, so that the advantage of inexpensive manufacture is maintained; in the case of applications where data is transmitted from the write/read station to the data carrier in encrypted form, decryption of the data should be made impossible, even if the encryption method is known, if only the RF signal from the write/read station can be received.

According to the invention these objects are achieved in a data transmission system of the kind set forth in that the data carrier is provided with a random number generator as well as with a memory for storing the random number generated.

Writing can thus take place in a memory (or a part of a memory which is also used for other purposes) in a manner which cannot be externally predicted. The random number generated in the data itself can be used for various purposes. However, it is always advantageous that the random number need not be transmitted from the write/read station to the data carrier: the transmission of data from the data carrier to the write/read station takes place at a very low energy level in the case of passive data carriers (depending on the geometrical dimensions, interception of data transmitted by the data carrier is possible only in a range of from a few centimeters to at the most 1 m). However, transmission of data from the write/read station to the data carrier takes place at a comparatively high level. (The dimensions of the transmission antenna are often from 2 to 3 times larger than the dimensions of the data carrier antenna; moreover, the transmission power is a factor of from 10 to 100 greater, because the write/read station performs the data transmission at the same energy level as the transfer of energy to the data carrier.) Thus, the random number cannot be intercepted secretly.

A feasible application of the random numbers consists in that the code of the data carrier contains or consists of the random number stored in the memory. Data carriers having a variable code are thus obtained. In that case it is particularly advantageous that the new code need never be transmitted from the write/read station to the data carrier; the advantage that a code is valid for a limited period of time only would otherwise be offset by the serious drawback that the new code can be intercepted in a very large range so that codes can be determined even more readily than if they were fixed.

In order to change the code of the data carrier, preferably the data carrier transmits first the old code and then the new code to the write/read station, the validity of the old code being tested in the write/read station and the new code being stored in the write/read station as the valid code only if the test result is positive. For example, in an access control system an intruder is thus prevented from gaining access by means of an arbitrary code in the case of a change of code.

In other applications, however, it may be advantageous to store only the random number in the memory in the case of a change of the code and to transmit it for the first time only in a different location. This may be advantageous in the case of large sporting events, for example the Vienna Spring Marathon. When a runner bearing a data carrier passes the starting line, he or she passes a write/read station and transmits the old code. Subsequently, the code is changed but not yet transmitted. At the turning point the new code is then transmitted to another write/read station. After completion of the event it is checked whether the data carrier of the runner indeed transmits this code. It is thus impossible for an accomplice of the runner to determine the code at the start by interception and so as to transmit it to the write/read station at the turning point while the runner turns around too early. In this case, preferably not the random number alone is used as the code, but rather a combination of fixed code and random number so that the code and the runner are always unambiguously linked.

Another application of the random numbers consists in that for the encrypted transmission of data from the write/read station to the data carrier the write/read station includes an encryption circuit and the data carrier includes a decryption circuit, the keyword being formed by a random number which is generated by the random number generator in the data carrier and transmitted to the write/read station. Thus, even if the encryption method is exactly known, decryption by merely intercepting the RF signal of the write/read station is impossible; to that end the signals from the data carrier should also be received, but that is possible only in its direct vicinity.

The invention will be described in detail hereinafter with reference to the accompanying drawing. The sole Figure shows the circuit diagram of a data carrier according to the invention. It includes an antenna coil L_{A} which receives an RF signal transmitted by a write/read station. The RF signal is rectified by a rectifier (not shown); the resultant direct voltage serves as the operating voltage after appropriate preparation (smoothing, voltage limitation). Also provided is a customary control circuit 2 which cooperates with a memory 3, for example an EEPROM. The control unit 2 can transmit data via a modulator 5 and receive data via a demodulator 4. A clock generator 1 derives a clock signal from the received RF signal by frequency division.

The data carrier transmits its code, stored in the memory, either whenever it enters an RF field of a write/read station or only if it receives an appropriate instruction from the write/read station.

The data carrier includes a random number generator 6 in addition to these known components. Under the control of the control unit 2, it generates a random number and stores it in the memory 3. A random number generator could be very simply implemented, for example as a linearly retrocoupled shift register clocked by a free-running oscillator. The various bits of the shift register are then combined, possibly via an inverter, by an Exclusive-Or-circuit and the result is applied to the input of the shift register. For each clock pulse a new, but predictable, bit combination is thus formed (so-called pseudo-random number) in the shift register. If the shift register is continuously supplied with asynchronous clock pulses (for as long as the operating voltage is present), however, the content of the shift register can no longer be foreseen from outside.

The random number which is generated by the random number generator 6, in response to an instruction from the control unit 2, and is stored in the memory 3, forms a part of the code to be transmitted by the data carrier.

The instant at which the random data is generated could be predetermined, for example by a special command from the write/read station. However, it is also possible for the random number to be generated automatically and in a “wired” fashion by the control logic circuitry, for example in response to each interrogation of the code or to every x^{th} interrogation. If in a given application no data is to be transmitted to the data carrier, demodulator 4 can be dispensed with in the latter case. If the generating of a random number is triggered by the write/read station, but no data is to be transmitted to the data carrier, the construction of the demodulator 4 may be very simple. For example, the write/read station can briefly interrupt the RF signal so as to trigger the generating of a random number: the demodulator 4 may then simply be a pause recognition circuit.

Thus, very little additional circuitry is required, in any case. However, a data carrier according to the invention can still be used in a so-called rolling code access control system. Protection against falsification is then enhanced by the fact that the code of each data carrier is renewed at cyclic intervals, so that knowledge of a given, access-authorizing code word can be used for only a limited period of time by an intruder (as opposed to fixed code systems).

The procedure using the described data carrier would be as follows:

The data carrier enters the field of the write/read station and transmits a code word valid thus far; subsequently, the random number generator generates a new code word which on the one hand is stored in the data carrier and on the other hand is transmitted to the write/read station.

The write/read station then checks the first transmitted code word for validity and, in the case of a positive result (data carrier has access authorization), stores the second code word transmitted by the data carrier as being a valid code word.

Depending on the relevant implementation, the write/read station need not transmit any instruction so as to initiate such a procedure. In addition to the fact that the circuitry for the write/read station and the data carrier is thus very simple, from a security point of view this has the major advantage that also the new code is transmitted exclusively by the data carrier, but never with the high transmission power of the write/read station; interception of the code, therefore, is just as difficult as in the case of fixed code data carriers, i.e. interception is possible only in the immediate vicinity of the data carrier.

In contrast therewith, when implemented in a conventional writable/readable data carrier system, the above method would enable interception over very long distances, because the new code word would have to be generated in the write/read station and subsequently transmitted from the write/read station to the data carrier via the communication path which can be readily invaded.

1. A system for the transmission of data between at least one write/read station and a plurality of data carriers, inductive coupling between write/read station and data carriers being used to transmit energy ard clock signals to the data carrier as well as data from the data carrier to the write/read station, characterized in that the data carrier is provided with a random number generator (6) as well as with a memory (3) for storing the random number generated.

2. A data transmission system as claimed in claim 1, characterized in that the code of the data carrier contains or consists of the random number stored in the memory (3).

3. A data transmission system as claimed in claim 2, characterized in that in order to change the code of the data carrier, the data carrier transmits first the old code and then the new code to the write/read station, the validity of the old code being tested in the write/read station and the new code being stored in the write/read station as the valid code only if the test result is positive.

4. A data transmission system as claimed in claim 2, characterized in that in the case of a change of the code the random number is only stored in the memory (3) and is transmitted for the first time only in a different location.

5. A data transmission system as claimed in claim 1, characterized in that for the encrypted transmission of data from the write/read station to the data carrier the write/read station includes an encryption circuit and the data carrier includes a decryption circuit, the keyword being formed by a random number which is generated by the random number generator (6) in the data carrier and transmitted to the write/read station.
